(19) United States
(12) Patent Application Publication
(10) Pub. No.: US 2011/0078009 A1
(43) Pub. Date: Mar. 31, 2011

(54) SEARCHABLE COUPON VALUES

(76) Inventor: Anthony G. Macaluso, Rancho Santa Fe, CA (US)

(21) Appl. No.: 12/786,354

(22) Filed: May 24, 2010

Related U.S. Application Data
(63) Continuation-in-part of application No. 12/057,046, filed on Mar. 27, 2008.
(60) Provisional application No. 61/180,716, filed on May 22, 2009.

(51) Int. Cl. G06Q 30/00

(52) U.S. Cl. 705/14.25

(57) ABSTRACT

A system, method, and a computer program product for pushing a coupon value to a user account are disclosed. In one aspect, a method includes receiving, at a computer system, a request to perform a search using a search term. The method includes processing, at the computer system, the received search term to determine whether the search term matches at least one of predetermined keywords, each keyword associated with at least one coupon. The method includes displaying, at the computer system, at least one of a search result or a coupon based on a result of the processing.

### CLAIM OF PRIORITY

This application is a continuation-in-part of U.S. patent application Ser. No. 12/057,046, filed on Mar. 27, 2009 and claims priority under 35 USC §119(e) to U.S. Patent Application Ser. No. 61/180,716, filed on May 22, 2009, the entire contents of which are hereby incorporated by reference.

### TECHNICAL FIELD

The subject matter described herein relates to techniques for pushing a value of a coupon to a user account.

### BACKGROUND

Traditionally, coupons have been used as a mechanism for sales promotions. Typically, coupons include a bar code that encodes the values associated with the coupons. In general, a user needs to print out the coupons and physically hand over the coupons to a cashier in order to redeem the values of the coupons. Coupons may be printed in a print medium (e.g., a magazine, newspaper, etc.) or displayed online for later printing. In some instances, coupons may even be pushed to a mobile device.

### SUMMARY

Techniques for searching for coupons and pushing coupon values are disclosed.

In one aspect, a method includes receiving, at a computer system, a request to perform a search using a search term. The method includes processing, at the computer system, the received search term to determine whether the search term matches at least one of predetermined keywords, each keyword associated with at least one coupon. The method includes displaying, at the computer system, at least one of a search result or a coupon based on a result of the processing.

Implementations can optionally include one or more of the following features. Displaying can include when determining, at the computer system, that the search term matches at least one of the predetermined keywords, the corresponding coupon associated with the matched at least one keyword can be displayed. Displaying the coupon can include displaying information that includes at least one of a value of the coupon, instructions on redeeming the coupon or expiration date of the coupon. The method can include receiving, at the computer system, data that includes user selection of the displayed coupon. Also, the coupon can be validated at the computer system based on the received data. The method can include identifying user information based on the received data, and determining a coupon value associated with the selected coupon. The method can include identifying a user account to credit the coupon value based on the user information obtained. Further, the method can include pushing the determined coupon value to the identified user account. Receiving the data can include receiving a request to answer a telephone call based on an abbreviated dialing code. The abbreviated dialing code can include a combination of numbers and symbols. The abbreviated dialing code can include a combination of numbers and symbols including at least one of a # symbol and a * symbol.

In another aspect, a system includes at least one server device operating at least one Website to interface with a user to receive a request to perform a search using a search term. The system includes an advertisement management system to: receive the request from the at least one server device, process the received search term to determine whether the search term matches at least one of predetermined keywords, each keyword associated with at least one coupon, and generate at least one of a search result or a coupon based on a result of processing the received search term. The at least one server device is further configured to receive the generated at least one of a search result or a coupon value from the advertisement management system and display the received at least one of a search result or a coupon on the at least one Website.

Implementations can optionally include one or more of the following features. The at least one server device can be further configured to display the coupon on the at least on Website including information associated with the coupon comprising at least one of a value of the coupon, instructions on redeeming the coupon or expiration date of the coupon. The at least one server device can be configured to display the coupon on the at least one Website including: when the advertisement management system determines that the search term matches at least one of the predetermined keywords, the at least one server device can be configured to display the corresponding coupon associated with the matched at least one keyword. The system can include a provisioning manager configured to receive a telephone call initiated in response to a user dialing an abbreviated dialing code on a communication device and identify a coupon value associated with the abbreviated dialing code. The abbreviated dialing code can be displayed with the displayed coupon. The system can include a user account manager communicatively coupled to the provisioning manager. The user account manager can be configured to maintain a plurality of user accounts external to the communication device. The system can include a user account identifier communicatively coupled to the provisioning manager and the user account manager. The user account identifier can be configured to identify a user account from the plurality of user accounts to push the identified coupon value. The user account identifier can be further configured to identify the user account based on a user selection of the displayed coupon. The system can further include a coupon validation system to: receive data comprising user selection of the displayed coupon; and validate the coupon based on the received data. The abbreviated dialing code can include a combination of numbers and symbols. The abbreviated dialing code can include a combination of numbers and symbols including at least one of a # symbol and a * symbol.

In another aspect, a system includes an advertiser interface system configured to receive coupon business rules associated with coupons. The system includes a user interface system configured to receive a request to perform a search using a search term. The system includes a campaign management system in communication with the advertiser interface system to generate or modify one or more of the coupons based on the received coupon business rules. The system includes an advertisement management system in communication with the user interface system and the campaign management system to process the received request. Processing the received request includes processing the received search term to determine whether the search term matches at least one of predetermined keywords, each keyword associated with at least one of the coupons, and displaying at least one of a search result or at least one of the coupons based on a result of the processing. The system includes a point-of-sale management system in communication with the campaign management system to receive and manage the generated or modified one or more coupons; and a point-of-sale data repository in communication with the point-of-sale management system to store the received and managed one or more coupons.

Implementations can optionally include one or more of the following features. The advertising management system can be configured to perform operations including: when determining that the search term matches at least one of the predetermined keywords, displaying the corresponding one or more coupons associated with the matched at least one keyword in a webpage or a print medium. The system can include a validation system in communication with the point-of-sale data repository, wherein the validation system is configured to validate the generated coupon. The system can further include a checkout computing system in communication with the point-of-sale data repository, wherein the checkout computing system is configured to receive a request to redeem at least one of the coupons.

Computer program products, tangibly embodied in a computer or machine readable medium are also described. Such computer program products may cause a data processing apparatus to conduct one or more operations described in this specification.

Similarly, systems are also described that may include a processor and a memory coupled to the processor. The memory may encode one or more programs that cause the processor to perform one or more of the method acts described in this specification.

Further, features described in this specification can be implemented as one or more methods or processes.

The subject matter described herein provides many advantages. For example, the subject matter described herein allows the values of the coupons to be pushed to a user's account instead of pushing the image of the coupons to a communication device. Pushing coupon values instead of the coupon images greatly reduces the need to print out the coupons, physically handing them over to a cashier, and having the cashier scan the coupons. In addition, pushing coupon values allows users to redeem the coupons faster and easier, and thus increase user participation in the sales promotions.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram of a process for pushing coupon values using abbreviated dialing codes.

FIG. 2 is a block diagram of a system for pushing coupon values using abbreviated dialing codes.

FIG. 3A is a functional block diagram showing communication routes in a system for pushing coupon values using abbreviated dialing codes.

FIG. 3B is a block diagram of a user account manager.

FIG. 4 is a process flow diagram of a process for interacting with the user account manager when pushing coupon values using abbreviated dialing codes.

FIG. 5 shows a system for generating coupons that can be redeemed by a user.

FIG. 6 shows an example system for enabling a user to access and obtain a value of a coupon.

FIG. 7 shows an example system for enabling a user to redeem the generated and opted-in coupons.

FIG. 8 shows an example process for generating a coupon.

FIG. 9 shows an example process for enabling a user to access and obtain a value of a coupon.

FIG. 10 shows a process flow diagram of a process for presenting coupon values associated with online searches.

FIG. 11 is a block diagram showing an example system for searching for coupons

Like reference symbols in the various drawings indicate like elements.

### DETAILED DESCRIPTION

Techniques for pushing coupon values (and not just images of the coupons) to a user account are disclosed. The coupon values can be pushed to a user account using abbreviated dialing code, for example. An abbreviated dialing code (ADC) is a shortened dialing code consisting of a sequence of symbols and decimal digits that are easy to remember. The sequence of symbols and decimal digits begins with one or more of the pound (#) symbol, the asterisk symbol (*) or a combination of both (e.g., #, ##, *, **, #*, *#, etc.). An abbreviated dialing code can be provisioned to any desired destination including a normal telephone number, a service, a product, digital content, an internet protocol (IP) address, etc. Automatically provisioning an ADC is described in detail in a co-pending U.S. patent application Ser. No. 12/034,518 (“AUTOMATIC PROVISIONING OF ABBREVIATED DIALING CODES”), the entire contents of which are hereby incorporated by reference. In the present application, an ADC is provisioned to coupon values, for example.

Typically, when a coupon is pushed to a communication device, only an image of the coupon is pushed to the user and not necessarily the actual value associated with the coupon. For example, a coupon pushed to a user may be an image that includes a bar code and/or an access code. In order to obtain the value of the coupon, a user usually has to print out the coupon and present the coupon to a participating retailer. A cashier at the participating retailer scans the coupon to apply the value of the coupon. Alternatively, a user may be able to input the access code at a website of the participating retailer to redeem the value of the coupon when making a purchase on-line. In both instances, since the user make an affirmative action to receive the value of the coupon, user participation may be discouraged.

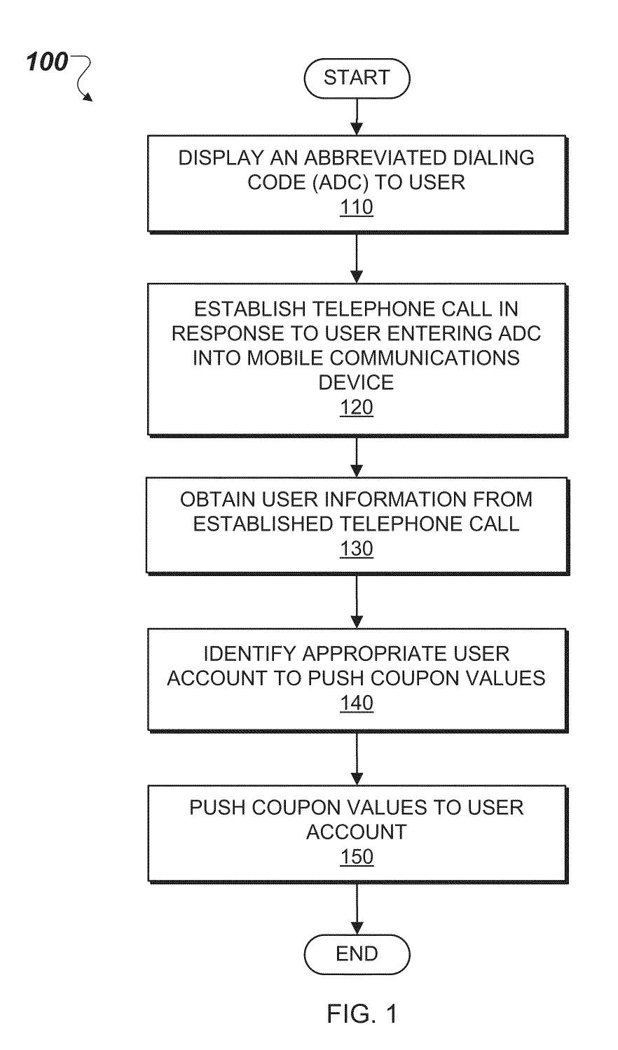

FIG. 1 is a process flow diagram illustrating an example process 100 for pushing coupon values to a communication device. At 110, the details of a coupon are displayed to a user. For example, an advertisement in a print medium (e.g., a magazine or a newspaper) may describe a 10% off coupon for next purchase at COSTCO®. A user is instructed to dial an ADC, #COSTCO® (#267826) to have the value of the 10% off coupon pushed to his/her COSTCO® account. Alternatively, a user already at a COSTCO® retail store sees a sign that states, “Dial #COSTCO® (#267826) on your cell phone to receive 10% off your purchase today.” Because the value of the coupon will be pushed to the user's COSTCO® loyalty account, the user is able to redeem the value of the coupon immediately during checkout. At 120, a telephone call is established from the communication device in response to a user dialing the ADC, #COSTCO®. Based on the telephone call, user information is identified at 130. For example, a telephone number of a mobile device that initiated the call and any information associated with the telephone number and/or the mobile device can be obtained from a wireless service provider. In some implementations, user information can be identified using signal system #7 (SS7), a set of telephony signaling protocols and the cellular tower that received the telephone signal from the mobile device as further described in co-pending U.S. Patent Application No. 60/890,821 (“AUTOMATIC PROVISIONING OF ABBREVIATED DIALING CODES”). Based on the user information identified, the user's account (COSTCO® account in this example) is also identified at 140. The value of the coupon is pushed to the user's account at 150. At checkout, the value of the coupon is automatically applied to the purchase price.

User information identified may also include various operational parameters such as different wireless carriers (Verizon®, Cingular®, etc), different transport technologies (CDMA, GMS, GPRS, EdVO, etc.), different mobile devices (Sony Ericsson®, Samsung®, Nokia®, etc.), software execution platforms (Java, Brew, IDEN, MMS, etc.), and the like. The operational parameters may be determined, for example, by having a server associated with the service being provided poll the mobile communications device to determine one or more of the parameters. Optionally, information, such as the wireless carrier and transport technology may be determined when the call is established. The appropriate user account or accounts for crediting the coupon value can be determined based on these operational parameters.

The user account can also be determined based on, for example, the telephone number of the mobile communications device. The telephone number of the user's mobile device can be identified by polling the mobile device and the identified telephone number can be used to search for all relevant user accounts associated with the telephone number.

In some implementations, a user may access a website or complete an off-line registration process with a communication service provider in which one or more of the operational parameters and the associated one or more user accounts are provided. Thereafter, when a call is received from the mobile communications device, a database associated with multiple users may be polled using the telephone number in order to identify the one or more user accounts associated with the telephone number. For instance, the user may pre-register with the user's communication service provider, a central user account manager or other appropriate systems a list of user accounts (e.g., customer loyalty accounts at retailers such as Costco®, Wal-Mart®, Safeway®, etc.) for crediting coupon values. Then, when a user dials an appropriate abbreviated dialing code for obtaining a coupon value, the registered user accounts associated with the telephone number are searched to identify the appropriate user account to credit the coupon value. For example, the value of a Costco® coupon will be credited to a Costco® customer loyalty account and a Safeway® coupon will be credited to a Safeway® customer loyalty account.

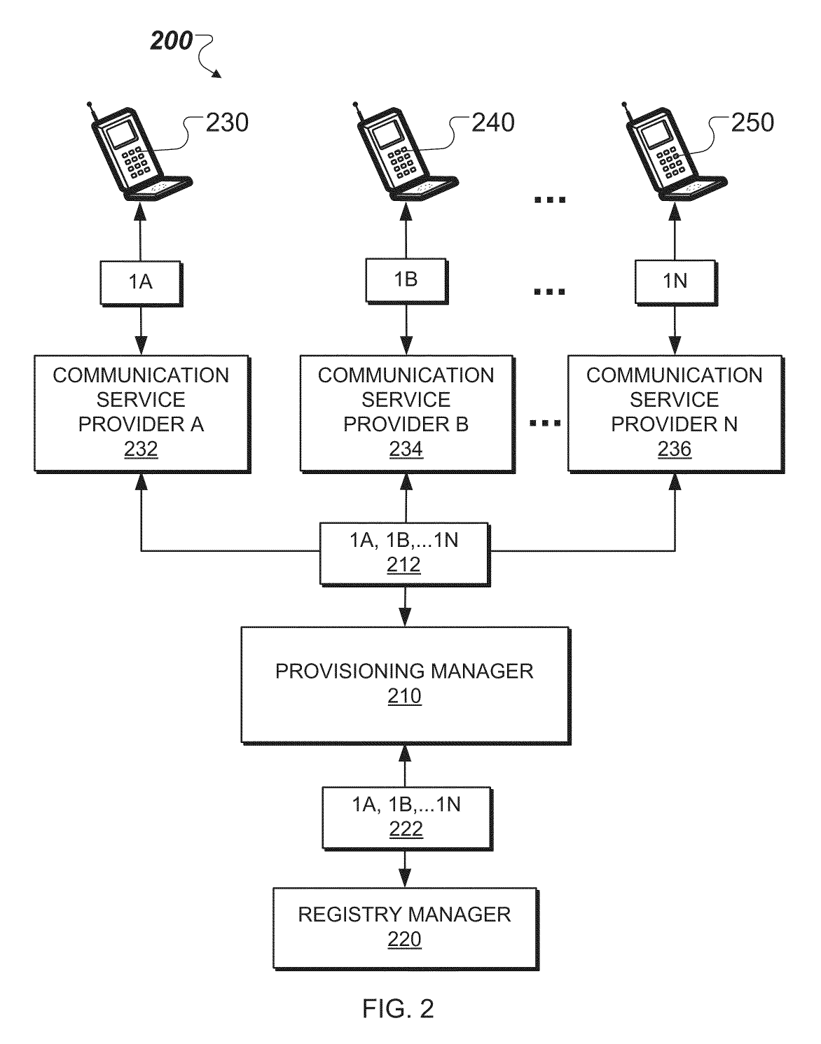

FIG. 2 is a block diagram of an example system 200 for pushing a coupon value to a user account. The system 200 includes a provisioning manager 210 designed to receive telephone calls (voice and/or data signals) from one or more communication devices 230, 240, and 250. The communication devices can include a mobile phone, a smart phone, a personal digital assistant (PDA), a desktop computer, laptop computer, etc. Each of the communication devices 230, 240, and 250 may be associated with different communication service providers (e.g., wireless service provider, such as Verizon®, Cingular®, Sprint®, etc.) 232, 234, 236, and each communication service provider may operate under different communication transport technologies. For example, the communication transport technologies can include wireless communication technologies, such as code division multiple access (CDMA), global system for mobile communication (GMS), general packet radio service (GPRS), evolution-data optimized (EdVO), etc.

In some implementations, the communication service providers can include traditional wired land-line communication service providers, such as AT&T®, Verizon®, Sprint®, etc. When users (not shown) dial abbreviated dialing codes (1A), (1B), . . . (1N) to initiate telephone calls, the abbreviated dialing codes (1A), (1B), . . . (1N) and other information associated with the communication devices 230, 240, and 250 are routed to the provisioning manger 210 through an appropriate communication network 212, such as the communication network associated with the service provider. The provisioning manager 210 obtains the information provisioned to the abbreviated dialing code and instructs the communication service provider 232, 234, and 236 on routing the telephone call. Optionally, the provisioning manager 210 may communicate with a registry manger 220 through an appropriate communication link 222 to verify registration of the received abbreviated dialing codes (1A), (1B), . . . (1N) or to register them when necessary.

Routing the telephone call includes using the information provisioned to the abbreviated dialing code to (1) determine a value of the coupon associated with the abbreviated dialing code and; (2) identify the appropriate user account for crediting the value of the coupon; and (3) crediting the identified user account with the value of the coupon. For example, the information provisioned with the abbreviated dialing code may instruct the service provider 232, 234, and 236 to search for registered user accounts associated with the user's telephone number (or any other operational parameters) to determine whether the user has a registered account appropriate for crediting the value of the coupon. When an appropriate user account is identified, the identified user account is credited with the value of the coupon. In the COSTCO® example, the provisioning manager 210 instructs the service provider 232, 234, and 236 to determine whether the user has a registered COSTCO® account available for crediting the value of the coupon.

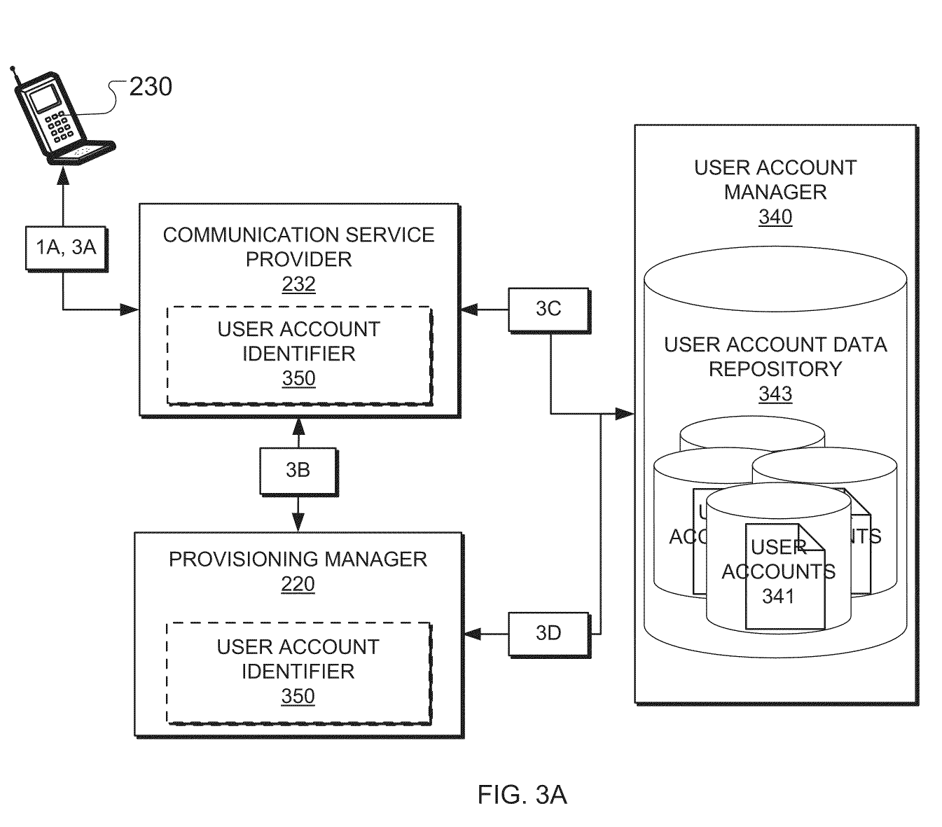

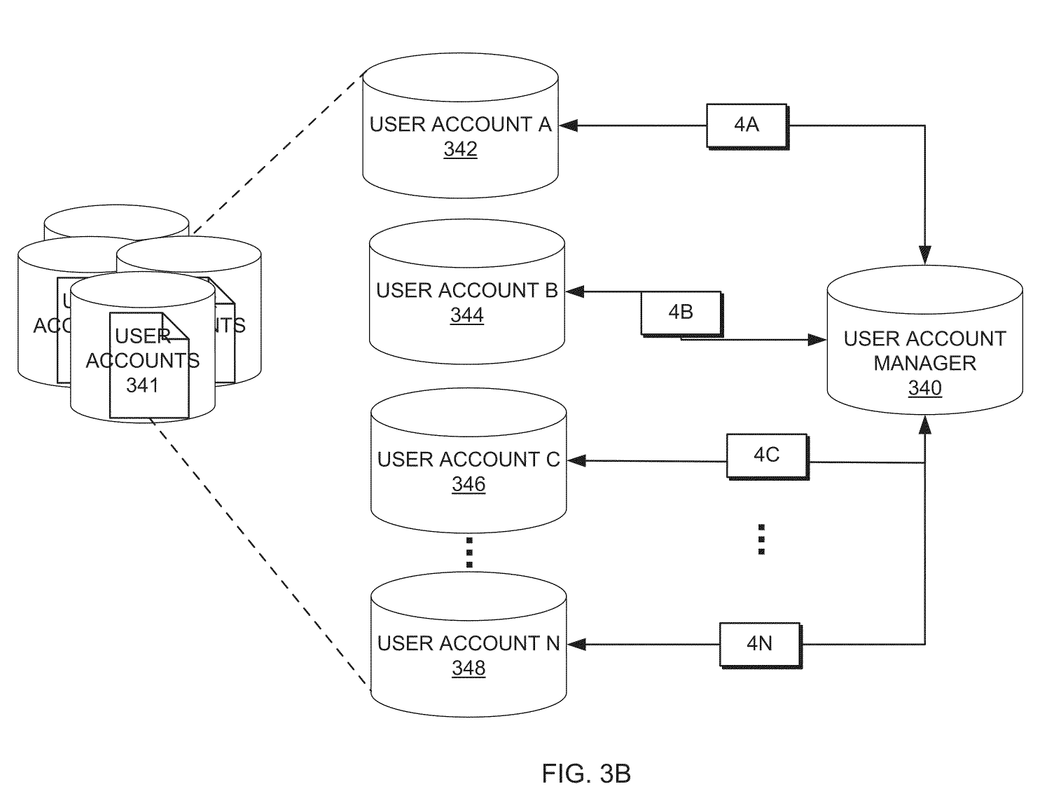

FIG. 3A is a block diagram showing an example system 300 for instructing a service provider to search for registered user accounts. In the example shown in FIG. 3A, the system 300 is illustrated for the communication device 230. However, the system 300 can be similarly implemented for other communication devices such as 240, 250, etc. When a user dials an abbreviated dialing code (1A) from a communication device 230, a telephone call is established (3A) with a communication service provider 232 to process the telephone call. The service provider 232 forwards (3B) the abbreviated dialing code (1A) and any identified operational parameters to a provisioning manager 220. The received abbreviated dialing code and the operational parameters are used by the provisioning manager 220 to determine coupon related information, such as the value of the coupon, associated with the abbreviated dialing code (1A). The provisioning manager 220 instructs the communication service provider 232 to search (3C) for appropriate user account for crediting the value of the coupon. A user account identifier 350 is in communication with the communication service provider 232 or a part of the communication service provider. For example, the user account identifier can be a software layer running on top of SS7 protocol at a server of the communication service provider. The user account identifier 350 communicates with a user account manager 340 to identify an appropriate user account based on the information obtained from the provisioning manager. The user account includes one or more loyalty accounts associated with a retailer. The user account manager 340 can be implemented using a server computer that includes a data repository 343, such as a database management system (DBMS) database, that store and maintain (e.g., via links) various registered user accounts 341. Alternatively, the data repository 343 can be located external to the user account manager as a network storage device, such as a part of storage area network (SAN). In some implementations, the user account manager 340 can be a part of the communication service provider 232.

In some implementations, the provisioning manager 220 includes the user account identifier 350 and the user account manager 340. The user account identifier 350 communicates (3D) with the user account manager 340 to identify the appropriate user account for crediting the coupon value. The provisioning manager 220 and/or the user account identifier 350 can credit the appropriate user account with the value of the coupon once identified.

Also, in some implementations, the user account manager 340 is communicatively linked to various specific user accounts 341. FIG. 3B illustrates the user account manager 340 managing various linked user accounts 341. The example shown in FIG. 3B shows the user accounts 341 to include N user accounts (user account A 342, user account B 344, user account C 346, . . . and user account N 348.) While only four specific user accounts (A, B, C, N, etc.) 342, 344, 346, and 348 are illustrated, the user account manager 340 can be linked to additional number of specific user accounts.

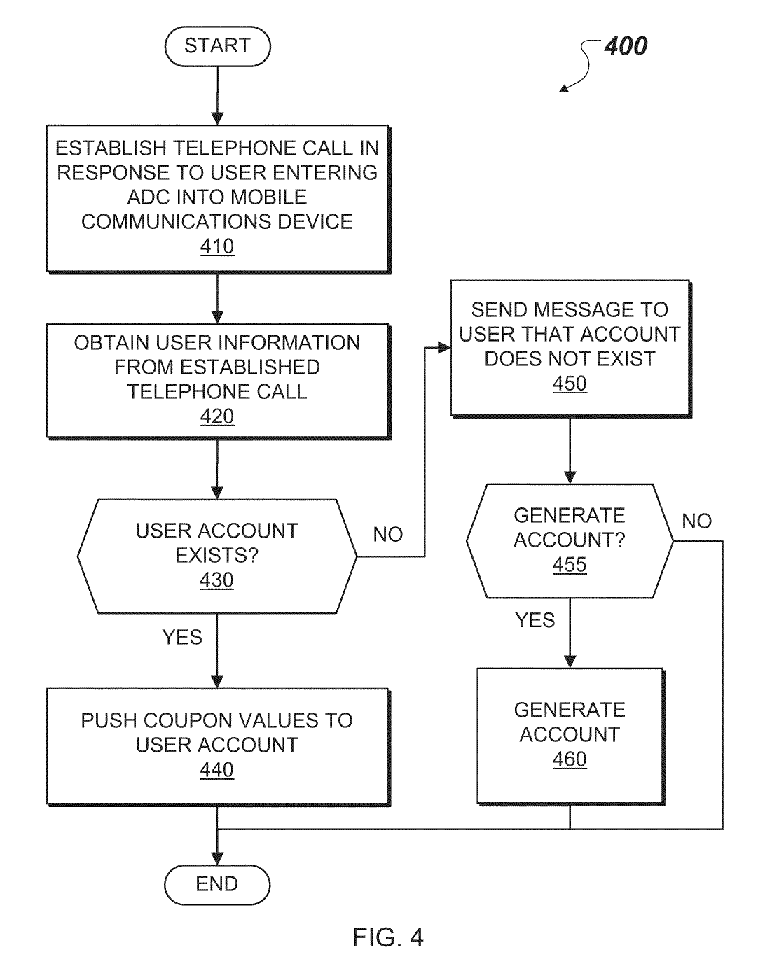

FIG. 4 is a process flow diagram illustrating an example process 400 of identifying an appropriate user account. In response to a user dialing an abbreviated dialing code from a communication device, a telephone call is established at 410. User information (e.g., telephone number and operational parameters) is obtained based on the established telephone call at 420. A user account manager is contacted to determine whether an appropriate user account exists at 430. For example, if the coupon value provisioned to the abbreviated dialing code is to be redeemed at COSTCO®, the determination at 430 is to check whether the user has a valid COSTCO® account. When it is determined that an appropriate user account does exist, the coupon value provisioned to the abbreviated dialing code is pushed 440 to the user account. However, when it is determined that an appropriate user account does not exist, the user is notified at 450 that an appropriate user account does not exist. The notification at 450 may be via SMS, e-mail, voice mail, etc.

In some implementations, the user is given the opportunity to sign up for the appropriate user account. For example, a SMS message is sent to the user (e.g., user's mobile device) with a link to a website that when activated by the user allows the user to sign up for the appropriate user account. Alternatively, the telephone call can be routed to an interactive voice response (IVR) system that instructs the user to sign up for the appropriate user account if desired. Based on input received from the user (e.g., providing information to create a new account), the system can determine 455 whether to generate a new account. Accordingly, a new account can be generated 460 as desired by the user. In some cases, the user account may exist but not registered (either with the service provider or with the user account manger directly.) In such cases, the user may be instructed to register the appropriate account, using an IVR for example.

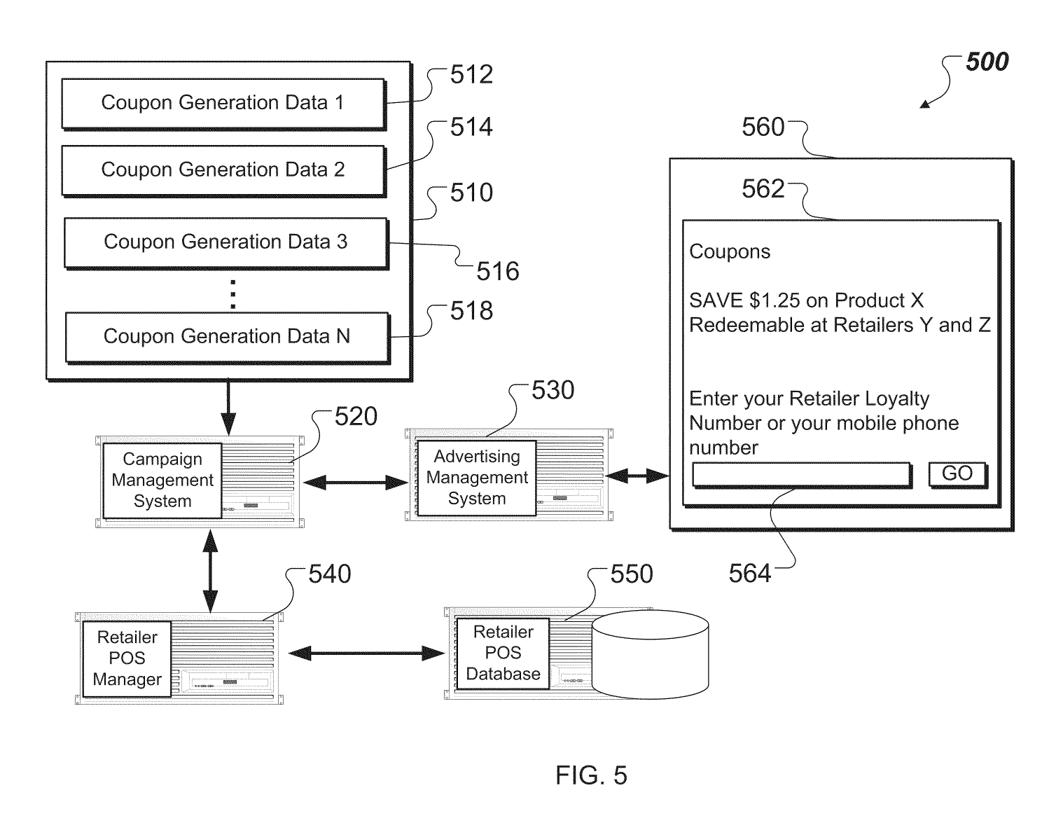

To present the coupon values to a user, the coupon values for user redemption can be generated by the retailers and/or manufacturers. FIG. 5 shows a system 500 for generating coupon values that can be redeemed by a user. The system 500 includes one or more data input unit 510 communicatively connected to a campaign management system 520. The campaign management system 520 is connected to a retailer point-of-sale (POS) manager 540 and an advertising management system 530. The advertising management system 530 is connected to one or more websites that will display the coupons. Also, the retailer POS manager 540 is connected to a retailer POS data repository 550.

The one or more data input units 510 can include a desktop computer, a server, etc. operated by the retailers and/or manufacturers. For example, the data input units 510 can include one or more computers located within the local area network (LAN) of the retailers and/or manufacturers. Thus, multiple retailers and/or manufacturers can be connected to the campaign management system 520. The campaign management system 520, the advertising management system 530, the retailer point of sale (POS) manager 540 and the advertisement server 560 can be implemented using one or more data processing devices such as a server. The retailer POS data repository 550 can be implemented using a DBMS database, for example. The connections between systems and data repository can be bidirectional over a network transport protocol such as hypertext transfer protocol (HTTP).

Using the data input unit 510, each retailer or manufacturer provides data 512, 514, 516, 518, etc related to a coupon that the retailer or manufacturer desires to create. The data 512, 514, 516, 518 provided can include the stock keeping unit (SKU) of the product, value of the coupon, information about the product and/or service for the coupon, a time frame during which the coupon can be redeemed, names and locations of retailer(s) that will honor the coupon, locations (e.g., websites) to display the coupons, etc. The data can be sent to the campaign management system 520 using an interface compatible with the campaign management system 520. This interface can be a web application, special software, etc.

The campaign management system 520 processes the received data 512, 514, 516, 518 to generate the coupon. The generated coupon is passed to the retailer POS manager 540 to manage the generated coupon that includes the information received from the retailer and/or manufacturer. The generated coupon can be an embedded web application used to display the coupon. For example, the generated coupon can be implemented as an embedded component such as an Active X DLL module in a web page.

The retailer POS manager 540 manages the generated coupons (current and expired) for each retailer and/or manufacturer. The retailer POS manager 540 is connected to the retailer POS data repository 550. The retailer POS data repository 550 can be used to store information associated with the generated coupons that can be redeemed at the POS retailer.

The campaign management system 520 delivers the generated coupon and/or advertisement to the advertisement system 530. For example, the advertisement management system 530 can be a specific advertisement server for a website entity, such as YAHOO®. The advertisement management system 530 operates to implement the generated coupon and/or advertisement as an embedded web application used to display the generated coupon and/or advertisement.

FIG. 5 also shows an example web application 562 embedded in a webpage 560 that displays the generated coupon and an associated advertisement. The example web application 562 displays an example coupon to save $1.25 on product X that can be redeemed at retailers Y and Z. The example web application 562 includes a user input area 564 to enable a user to enter the user's retailer loyalty number and/or the user's mobile phone number. The example web application 562 can include additional information about the product or sever, such as the manufacturer information, size, retail price, image of the product, etc.

When the user enters the user's retailer loyalty number, for example for a grocery store, such as VONS®, the value of the coupon is automatically credited to the user's loyalty account for VONS®. The value of the coupon is waiting to be redeemed at the point of sale, any one of the VONS® retail store. In such manner, the user does not need to print out the coupon and take it with him/her to the point of sale retail store to redeem the coupon.

In some implementations, the value of the coupon can be credited to retailer loyalty accounts of non-brick and mortar or online retailers, such as BUY.COM® or AMAZON.COM®.

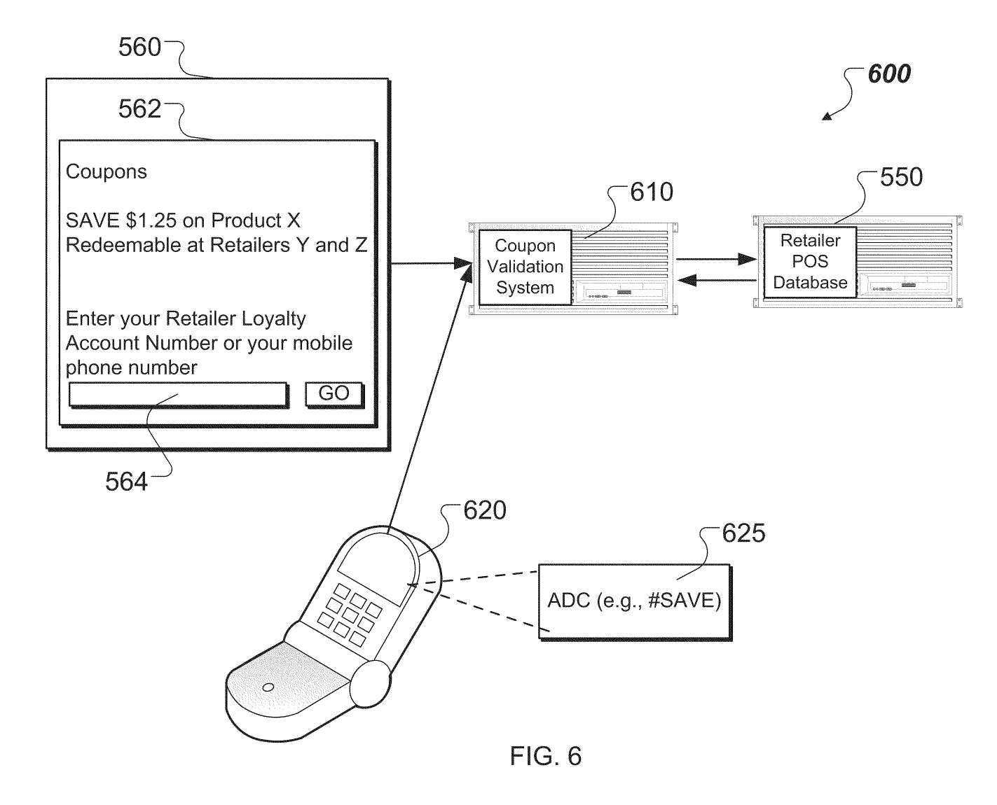

FIG. 6 shows an example system 600 for enabling a user to access and obtain a value of a coupon. As described above, when the user can enter his/her loyalty account number for a specific retailer, such as VONS® grocery store into the user input area 564, the value of the coupon is sent to a coupon validation system 610 to validate the coupon. For example, the coupon validation system can perform one or more of the following: (1) check for authenticity of the coupon; (2) check to make sure the coupon has not expired; (3) check to make sure the retailer associated with the retailer loyalty program will honor the coupon; (4) check to makes sure the retailer has the product in stock; (5) check to make sure the value of the coupon is valid; (6) check for extra promotions such as double coupon values honored by the retailer; etc. Once the coupon is validated, the coupon validation system 610 forwards the coupon value to the retailer POS data repository 550 for storage. Once received by the retailer POS data repository, the coupon value is ready to be redeemed by the user at the POS retail store, for example.

In some implementations, the user can enter an ADC 625, such as #SAVE, #COUPON or other appropriate codes that indicate the coupon value into the user's mobile phone 625. Using the techniques as described with respect to FIGS. 1-4 above, the ADC is attached to the coupon value and the attached coupon value is sent to the user's retailer loyalty account. As described with respect to FIG. 4 above, the user may have previously associated a particular retailer loyalty account number to his/her phone number. Alternatively, the user can register a preexisting retailer loyalty account through an IVR. Also, the user can create a new retailer loyalty account, using an IVR for example. By dialing the ADC, the user is opting-in to the coupon promotion.

The coupon value indicated by the ADC is received by the coupon validation system 610 for validation as described above. Also, the validated coupon is passed to the retailer POS data repository 550 for user redemption as described above.

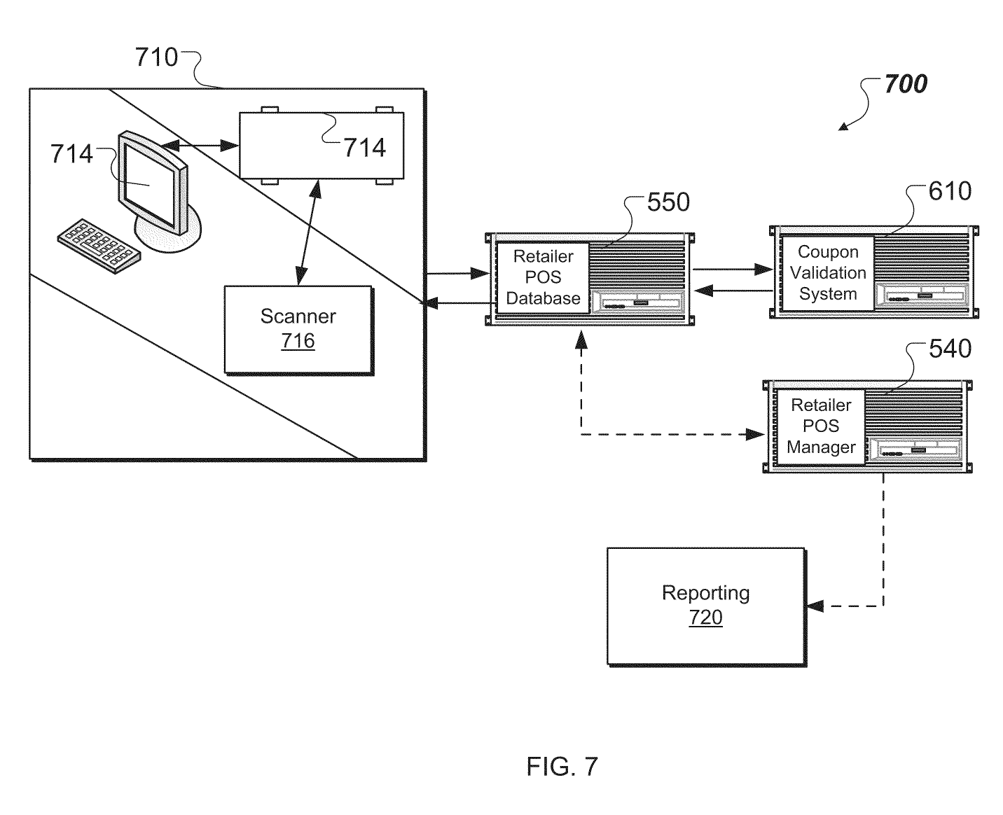

In addition, when the user dials the ADC, the user can receive a message (e.g., a push text message) with information associated with a shopping list. For example, the message can include an embedded hyperlink address for a location where the user can access the shopping list. The shopping list can include one or more coupon values that can be redeemed by the user using techniques described with respect to FIGS. 1-6 above and FIG. 7 below. The shopping list can include a list of suggested coupons for the user based on an analysis of the user's past shopping history. Also, the shopping list can be generated, saved and updated by the user for interactive shopping experience.

In some implementations, the user can dial the ADC on a landline telephone to opt-in to the coupon promotion and send the coupon value to the user's retailer loyalty account.

FIG. 7 shows an example system 700 for enabling a user to redeem the generated and opted-in coupons. The coupon redemption system 700 includes a checkout computer system 710 that can be found at a checkout counter. The checkout computer system 710 can include a computing device 712, such as an electronic cash register or a computer operating cash register software connected to an output device 714 such as a monitor and an input device 716 such as a scanner. The checkout computing system 710 is connected to the retailer POS data repository 550, and the retailer POS data repository 550 is connected to the coupon validation system. Optionally, the retailer POS data repository 550 can be connected to retailer POS manager 540 to enable reporting of the generated and redeemed coupons.

When the user purchases a product at the POS retailer, the checkout computing system 710 communicates with the retailer POS data repository 550 for one or more coupon values associated with the purchased product that the user opted-in. In particular, the checkout computing system 710 can check for all coupon values available for the user's retailer loyalty account. The coupon values available in the retailer POS data repository 550 have been validated by the coupon validation system 610 as described above. In this manner, the user can redeem coupon values without having to print out the coupon and carry the coupon to the POS retailer.

In some implementations, the retail POS data repository 550 is connected to the retail POS manager 540. The retail POS manager can access the coupon data stored in the retail POS repository 550 to generate a report 720. The generated report 720 can be used to manage the generated coupons. In addition, the generated report 720 can be sent to the user to inform and notify the user of the opted-in coupons, redeemed coupons, expired coupons, etc.

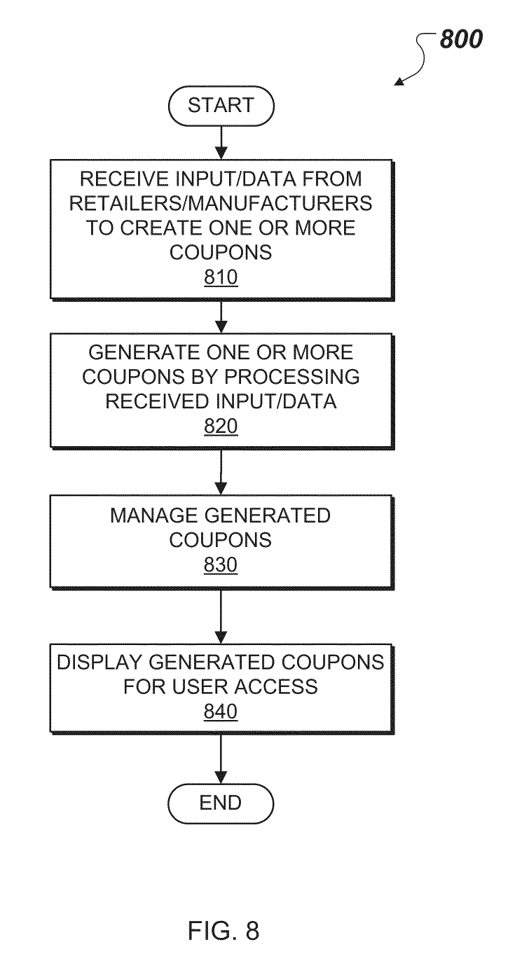

FIG. 8 shows an example process for generating a coupon. Input that includes data representing one or more coupons desired to be generated is received 810 from a retailer and/or manufacturer. The received input can include data such as the stock keeping unit (SKU) of the product, value of the coupon, information about the product and/or service for the coupon, a time frame during which the coupon can be redeemed, names and locations of retailer(s) that will honor the coupon, locations (e.g., websites) to display the coupons, etc.

The received input is processed by the campaign management system 520 to generate 820 the one or more coupons desired by the retailer and/or manufacturer. The generated coupons are forwarded to the retailer POS manager 540 to manage 830 the generated coupon. For example, the retailer POS manager 540 can be notified of the generated coupons, including the details of the generated coupons, so that the POS retailer can be ready to enable users to redeem the coupons.

Also, the generated coupons are forwarded to appropriate advertising management system 530, to enable the advertising management system 530 to display 840 the generated coupons. As described above, the generated coupons can be implemented as embedded web application to be displayed at a website such as YAHOO!®.COM. In some implementations, the coupons can be displayed in a conventional print media such as a magazine or a newspaper. The displayed coupons displayed in print media can include an abbreviated dialing code for a user to dial as describe above.

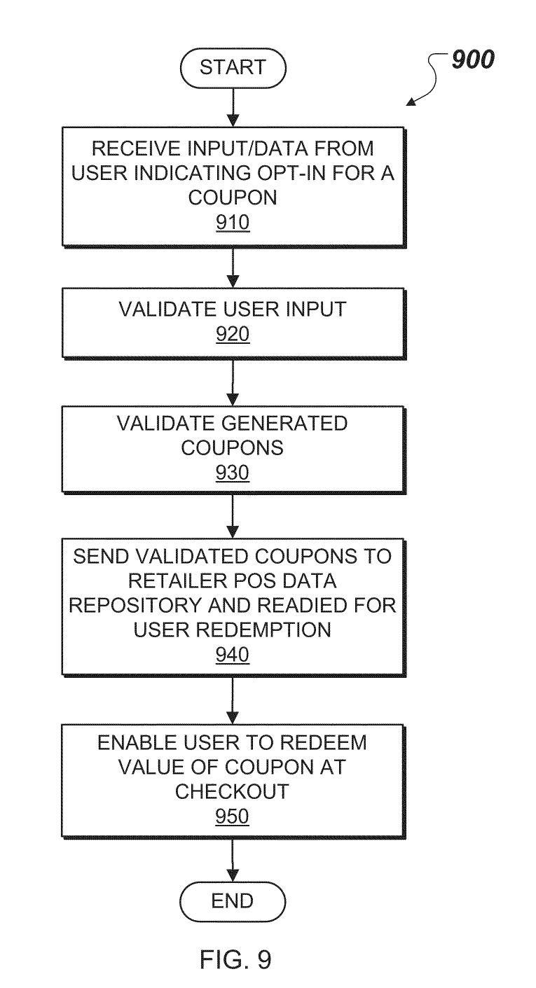

FIG. 9 shows an example process for enabling a user to access and obtain a value of a coupon. Input from one or more users is received 910. The received input indicates that the user is opting-in for the advertised or displayed coupon. As describe above, the user can (1) enter his/her retailer loyalty account number or phone number in an embedded web application; or (2) dial an ADC from a mobile phone or a landline phone.

The received retailer loyalty account number of the user and/or user's phone number are validated 920. For example, the retailer loyalty account number can be checked with the retailer POS manager 540 to makes sure the account number is a valid account number. Also, the phone number received from the user from the embedded web application or identified when the ADC is received from the user can be checked for retailer loyalty account number(s) associated with or registered for the phone number.

Also, the coupon opted-in by the user can be validated 930 as described with respect to FIGS. 6-7. The validated coupons are sent 940 to the retailer POS data repository 550 and readied for user redemption. When user purchases one or more product items associated with thee validated coupon, the value of the coupon is redeemed 950 at the POS.

In another aspect, the techniques and systems for pushing coupon values can be implemented with online searches. For example, in response to user initiated searches on a Web page, the Web page can return the results of the searches and any corresponding coupons available for the returned search results.

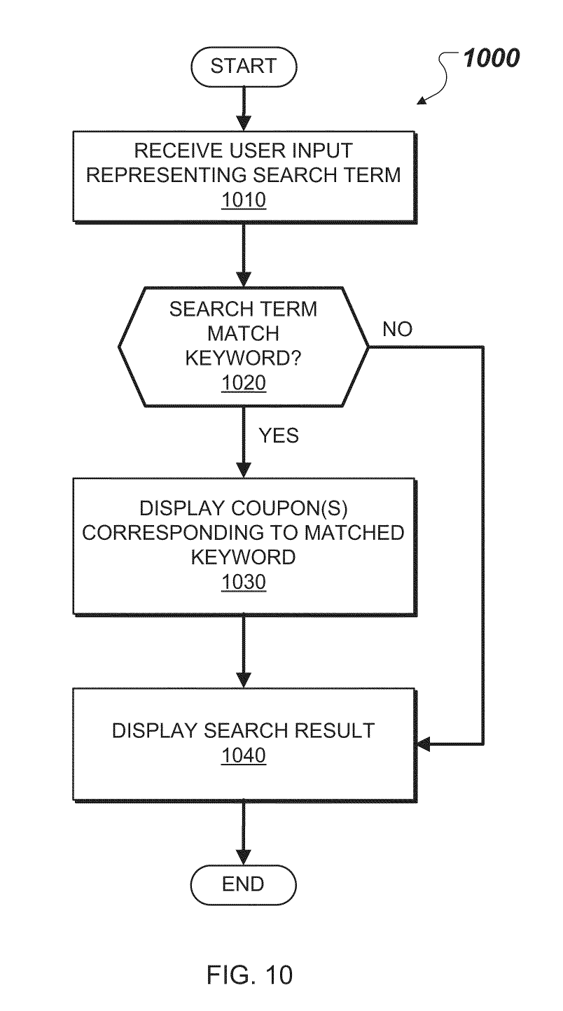

FIG. 10 is a process flow diagram showing a process 1000 for presenting coupon values associated with online searches. At a Web page, a computer system receives user input representing a search term or phrase (1010). The system processes the search terms to determine whether the search terms match one or more of predetermined keywords corresponding to stored coupons (1020). When the search terms matches one or more of the predetermined keywords, a visual indication of the coupon(s) corresponding to the matched keywords is presented to the user (1030). Also, the display results can be presented to the user (1040). When the search terms do not match any of the keywords, the search results can be displayed (1040) but there are no coupons to be displayed.

For example, an advertising banner can be displayed on the screen to present the available coupons corresponding to the search terms. As described with respect to FIG. 5 above, the available coupons can be presented using an embedded web application. For example, the generated coupon can be implemented as an embedded component such as an Active X DLL module in the Web page. The displayed coupon can include information about the coupons and the associated product or service as described with respect to FIGS. 5-7 above. The information can include the value of the coupon, the expiration date of the coupon and information describing how the user can, redeem the coupon value.

Using the method described in FIG. 10, the user can find the available discount coupons while searching on a Web page, such as the Yellow Pages®, Yahoo®, Google®, etc. For example, the user can enter and search for Papa John's Pizza® by entering the terms “Papa” or “John” or “pizza” or a combination of the terms, such as “Papa John's Pizza.” The keywords associated with these search terms can be “pizza,” “papa,” and “john.” These keywords can be stored at a data repository. In response to the user's search, one or more of these keywords can be identified and matched to the search terms. In response to matching the keywords, the corresponding discount coupons for Papa John's Pizza® can be displayed along with the search results.

Also, the coupons can be presented in response to search requests that indicate a desired service or products at a desired location. For example, the user can search for pest control services by entering the term “Orkin” and the location, such as the city, state, zip code, etc. The keywords associated with this search can include “pest,” “exterminator,” “orkin,” and “San Diego.” In response to the user's search, one or more of these keywords can be identified and matched to the search terms. In response to matching the keywords, the corresponding discount coupons for Orkin® in San Diego can be displayed along with the search results.

The system waits for user input selecting one or more of the presented coupons (1040). Once user selection is received, the user can validate, opt-in and redeem the selected coupon as described with respect to FIGS. 6-7 and 9.

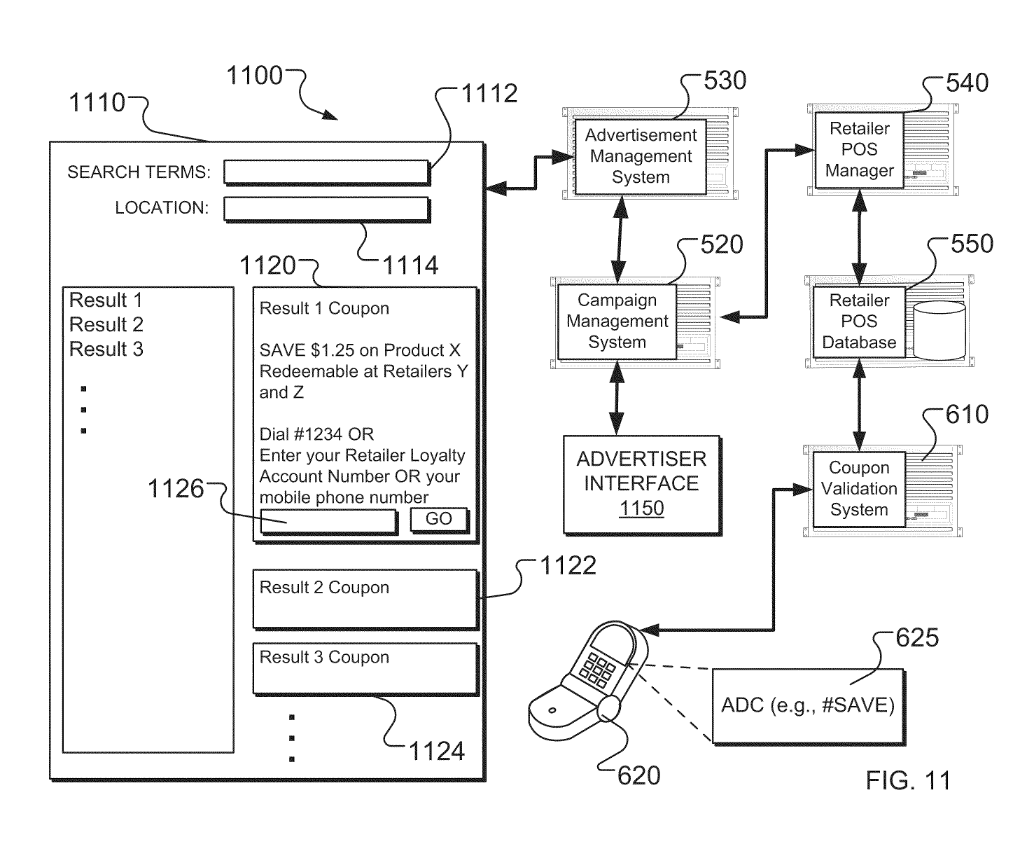

FIG. 11 is a block diagram showing an example computer system for searching for coupons. The computer system 1100 includes an advertiser interface 1150 to communicate with a campaign management system 520. The campaign management system 520 can communicate with a retailer point-of-sale (POS) manager 540 and an advertising management system 530. The advertising management system 530 can communicate with one or more Websites 1110 to display the coupons. The one or more Websites 1110 can be operated by one or more server devices. Also, the retailer POS manager 540 can communicate with a retailer POS data repository 550.

The example Website 1110 can include a Website where a user can perform keyword searches. The Website 1110 can include various user interfaces (e.g., buttons, text input windows, menus, etc.), such as a search term input receiving interface 1112 and an optional location input receiving interface 1114. The Website 1110 can also include a search result display window 1130 and various coupon display windows 1120, 1122, 1124, etc. In response to the user input received through the user interfaces 1112 and 1114, the search results can be displayed in the search result display window 1130. Also, available coupons corresponding to the search results can be displayed in the coupon display window 1120, 1122, 1124, etc.

The advertiser interface 1150 can include data processing devices, such as a desktop computer, a server, etc. operated by the advertiser (e.g., retailers, manufacturers, etc.) For example, the advertiser interface 1150 can include one or more computers located within the local area network (LAN) of the retailers and/or manufacturers. Thus, multiple retailers and/or manufacturers can be connected to the campaign management system 520. The campaign management system 520, the advertising management system 530, the retailer point of sale (POS) manager 540 and the advertisement server 560 can be implemented using one or more data processing devices such as a server. The retailer POS data repository 550 can be implemented using a DBMS database, for example. The connections between systems and data repository can be bidirectional over a network transport protocol such as hypertext transfer protocol (HTTP).

Using the advertiser interface 1150, each advertiser can directly enter coupon business rules related to a coupon that the advertiser desires to create or modify. For example, the advertiser can enter the stock keeping unit (SKU) of the product, value of the coupon, information about the product and/or service for the coupon, a time frame during which the coupon can be redeemed, names and locations of retailer(s) that will honor the coupon, locations (e.g., websites) to display the coupons, etc. The coupon business rules entered by the advertiser can be sent to the campaign management system 520 using an interface compatible with the campaign management system 520. This interface can be a web application, special software, etc.

The campaign management system 520 processes the received coupon business rules to generate and/or modify one or more coupons. The generated or modified coupon is passed to the retailer POS manager 540 to manage the generated or modified coupon that includes the coupon business rules entered by the advertiser. The generated or modified coupon can include an embedded web application used to display the coupon. For example, the generated coupon can be implemented as an embedded component such as an Active X DLL module in a web page.

The retailer POS manager 540 can manage the generated and/or modified coupons (current and expired) for each retailer and/or manufacturer. The retailer POS manager 540 can communicate with the retailer POS data repository 550. The retailer POS data repository 550 can be used to store information associated with the generated and/or modified coupons that can be redeemed at the POS retailer.

The campaign management system 520 delivers the generated coupon and/or advertisement to the advertisement system 530. For example, the advertisement management system 530 can be a specific advertisement server for a website entity, such as Google®. The advertisement management system 530 can operate to implement the generated coupon and/or advertisement as an embedded web application used to display the generated coupon and/or advertisement. When a user enters a search term, that search term can be passed to the advertisement management system 530 to determine whether the search terms match any of the keywords associated with an existing coupon. When a match is detected, the advertising management system 530 can display the corresponding coupons by passing data associated with the coupons to the server devices that operate the one or more Websites 1110. The coupons are displayed on the one or more Websites.

The example coupon display interfaces 1120, 1122, and 1124 include information about the coupons, such as information describing that the user can save $1.25 on product X that can be redeemed at retailers Y and Z. Also, a Web application can be implemented to provide a user input area 1126 to allow a user to enter the user's retailer loyalty number and/or the user's mobile phone number. Also, an abbreviated dialing code can be presented to the user. The coupon display window can include additional information about the product or sever, such as the manufacturer information, size, retail price, image of the product, etc.

When the user enters the user's retailer loyalty number, for example for a grocery store, such as VONS®, the value of the coupon is automatically credited to the user's loyalty account for VONS®. Then the credited value of the coupon is waiting to be redeemed at the point of sale (e.g., any one of the Vons® retail store). In such manner, the user does not need to print out the coupon and take it with him/her to the point of sale retail store to redeem the coupon.

In some implementations, the value of the coupon can be credited to retailer loyalty accounts of non-brick and mortar or online retailers, such as BUY.COM® or AMAZON.COM®.

As described above, when the user enters his/her loyalty account number for a specific retailer, such as VONS® grocery store into the user input area 1126, the value of the coupon can be sent to a coupon validation system 610 to validate the coupon. For example, the coupon validation system can perform one or more of the following: (1) check for authenticity of the coupon; (2) check to make sure the coupon has not expired; (3) check to make sure the retailer associated with the retailer loyalty program will honor the coupon; (4) check to makes sure the retailer has the product in stock; (5) check to make sure the value of the coupon is valid; (6) check for extra promotions such as double coupon values honored by the retailer; etc. Once the coupon is validated, the coupon validation system 610 forwards the coupon value to the retailer POS data repository 550 for storage. Once received by the retailer POS data repository, the coupon value is ready to be redeemed by the user at the POS retail store, for example.

In some implementations, the user can enter an ADC 625, such as #SAVE, #COUPON or other appropriate codes that indicate the coupon value into the user's mobile phone 625. Using the techniques as described with respect to FIGS. 1-4 above, the ADC can be associated with the coupon value, and the associated coupon value can be credited to the user's retailer loyalty account. As described with respect to FIG. 4 above, the user may have previously associated a particular retailer loyalty account number to his/her phone number. Alternatively, the user can register a preexisting retailer loyalty account through an IVR. Also, the user can create a new retailer loyalty account, using an IVR for example. By dialing the ADC, the user is opting-in to the coupon promotion.

The coupon value indicated by the ADC can be received by the coupon validation system 610 for validation as described above. Also, the validated coupon is passed to the retailer POS data repository 550 for user redemption as described above.

In addition, when the user dials the ADC, the user can receive a message (e.g., a push text message) with information associated with a shopping list. For example, the message can include an embedded hyperlink address for a location where the user can access the shopping list. The shopping list can include one or more coupon values that can be redeemed by the user using techniques described with respect to FIGS. 1-11 above. The shopping list can include a list of suggested coupons for the user based on an analysis of the user's past shopping history. Also, the shopping list can be generated, saved and updated by the user for interactive shopping experience.

Text messages can be sent to the user's device through a Web interface to receive information about the coupons. The text messages can include various coupon related information such as the value, expiration date, redemption locations, etc.

In some implementations, a reporting mechanism can be implemented to present demos, products, request all pertinent reporting information, etc. For example, each advertiser can demo the coupon including generating, modifying, validating and redeeming the coupons. Also, the advertiser can request and obtain a list of products/services and associated coupons available for redemption. Further, the advertiser can request and obtain a report detailing information related to each coupon, such as the redemption history of each coupon, validity of each coupon, etc. Each advertiser can create an advertiser account to maintain and manage the coupons for each advertiser. The reporting mechanism can use the advertiser account to generate and store the history and reports associated with coupons.

In another aspect, a Web validation interface or a dial-in validation (e.g., IVR) can be implemented to allow each advertiser to validate the coupon and/or customer. For example, the advertiser can validate the coupons generated or coupons opted-in by the user. When the user enters the information provided in the coupon display, interface, a notice or message can be sent to the advertiser to validate the coupons and/or the user. If the user doe not have an existing retailer loyalty account, the advertiser can send a message to the user requesting the user to sign up for an account in order to redeem the coupon, for example.

Because the value of the coupon is pushed to a user account, the extra step required to print out the coupon is no longer needed. By eliminating the need to print out the coupon, a user is able to redeem a coupon faster and in an efficient manner.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” includes any computer program product, apparatus and/or device (e.g., magnetic discs, optical disks, memory, Programmable Logic Devices (PLDs)) used to provide machine instructions and/or data to a programmable processor. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although a few variations have been described in detail above, other modifications are possible. For example, the logic flow depicted in the accompanying figures and described herein does not require the particular order shown, or sequential order, to achieve desirable results. In particular, the provisioning manager 550, 350, and 210 can control all aspects of the process to automatically provision an ADC. In such instances, the registry manager merely forwards the instructions for routing a telephone call initiated by dialing the ADC. The registry manager can also manage registration of ADCs. Other embodiments may be within the scope of the following claims and appendix.

What is claimed is:

1. A method comprising:
receiving, at a computer system, a request to perform a search using a search term;
processing, at the computer system, the received search term to determine whether the search term matches at least one of predetermined keywords, each keyword associated with at least one coupon; and
displaying, at the computer system, at least one of a search result or a coupon based on a result of the processing.

2. The method of claim 1, wherein displaying the coupon comprises displaying information that includes at least one of a value of the coupon, instructions on redeeming the coupon or expiration date of the coupon.

3. The method of claim 1, wherein displaying comprises:
when determining, at the computer system, that the search term matches at least one of the predetermined keywords, displaying the corresponding coupon associated with the matched at least one keyword.

4. The method of claim 3, further comprising:
receiving, at the computer system, data comprising user selection of the displayed coupon; and
validating the coupon at the computer system based on the received data.

5. The method of claim 4, comprising:
identifying user information based on the received data;
determining a coupon value associated with the selected coupon;
identifying a user account to credit the coupon value based on the user information obtained; and
pushing the determined coupon value to the identified user account.

6. The method of claim 4, wherein receiving the data comprises:
receiving a request to answer a telephone call based on an abbreviated dialing code.

7. The method of claim 6, wherein the abbreviated dialing code comprises a combination of numbers and symbols.

8. The method of claim 6, wherein the abbreviated dialing code comprises a combination of numbers and symbols including at least one of a # symbol and a * symbol.

9. A system comprising:
at least one server device operating at least one Website to interface with a user to receive a request to perform a search using a search term; and
an advertisement management system to:
receive the request from the at least one server device,
process the received search term to determine whether the search term matches at least one of predetermined keywords, each keyword associated with at least one coupon, and generate at least one of a search result or a coupon based on a result of processing the received search term,
wherein the at least one server device is further configured to receive the generated at least one of a search result or a coupon value from the advertisement management system and display the received at least one of a search result or a coupon on the at least one Website.

10. The system of claim 9, wherein the at least one server device is further configured to display the coupon on the at least on Website including information associated with the coupon comprising at least one of a value of the coupon, instructions on redeeming the coupon or expiration date of the coupon.

11. The system of claim 9, wherein the at least one server device is configured to display the coupon on the at least one Website comprising:
when the advertisement management system determines that the search term matches at least one of the predetermined keywords, the at least one server device is configured to display the corresponding coupon associated with the matched at least one keyword.

12. The system of claim 11 further comprising:
a provisioning manager configured to receive a telephone call initiated in response to a user dialing an abbreviated dialing code on a communication device and identify a coupon value associated with the abbreviated dialing code, wherein the abbreviated dialing code is displayed with the displayed coupon;
a user account manager communicatively coupled to the provisioning manager, the user account manager configured to maintain a plurality of user accounts external to the communication device; and
a user account identifier communicatively coupled to the provisioning manager and the user account manager, the user account identifier configured to identify a user account from the plurality of user accounts to push the identified coupon value.

13. The system of claim 12, wherein the user account identifier is further configured to:
identify the user account based on a user selection of the displayed coupon.

14. The system of claim 11, further comprising a coupon validation system to:
receive data comprising user selection of the displayed coupon; and
validate the coupon based on the received data.

15. The system of claim 11, wherein the abbreviated dialing code comprises a combination of numbers and symbols.

16. The system of claim 11, wherein the abbreviated dialing code comprises a combination of numbers and symbols including at least one of a # symbol and a * symbol.

17. A system comprising:
an advertiser interface system configured to receive coupon business rules associated with coupons;
a user interface system configured to receive a request to perform a search using a search term;
a campaign management system in communication with the advertiser interface system to generate or modify one or more of the coupons based on the received coupon business rules;
an advertisement management system in communication with the user interface system and the campaign management system to process the received request comprising:
process the received search term to determine whether the search term matches at least one of predetermined keywords, each keyword associated with at least one of the coupons, and
display at least one of a search result or at least one of the coupons based on a result of the processing;
a point-of-sale management system in communication with the campaign management system to receive and manage the generated or modified one or more coupons; and
a point-of-sale data repository in communication with the point-of-sale management system to store the received and managed one or more coupons.

18. A system as in claim 17, wherein the advertising management system is configured to perform operations comprising:
when determining that the search term matches at least one of the predetermined keywords, display the corresponding one or more coupons associated with the matched at least one keyword in a webpage or a print medium.

19. A system as in claim 17, further comprising a validation system in communication with the point-of-sale data repository, wherein the validation system is configured to validate the generated coupon.

20. A system as in claim 17, further comprising a checkout computing system in communication with the point-of-sale data repository, wherein the checkout computing system is configured to receive a request to redeem at least one of the coupons.
